(19) United States
(12) Patent Application Publication
(10) Pub. No.: US 2023/0067285 A1
(43) Pub. Date: Mar. 2, 2023

(54) LINKAGE DATA GENERATOR

(71) Applicant: PayPal, Inc., San Jose, CA (US)

(72) Inventors: Sri Harish Sridhar, Vellore (IN); Sasikanth Natarajan, Chennai (IN); Karan Samirbhai Shah, Chennai (IN); Srinivasabharathi Selvaraj, Medavakkam (IN)

(21) Appl. No.: 17/580,001

(22) Filed: Jan. 20, 2022

(30) Foreign Application Priority Data
Aug. 28, 2021 (IN) 202141039071

(51) Int. Cl. G06F 21/62; G06F 11/34; G06N 3/04; G06F 16/22; G06F 16/28

(52) U.S. Cl. CPC G06F 21/6218; G06F 11/3447; G06F 16/22; G06F 16/285; G06N 3/0454

(57) ABSTRACT

A system can determine a cluster of tables from a plurality of tables, determine, using a neural network, a link between a pair of columns from respective tables of the cluster of tables, wherein the pair of columns satisfy a relatedness criterion, and classify, using the neural network, the link according to a link classification criterion, wherein the link satisfies the link classification criterion.

### CROSS-REFERENCE TO RELATED APPLICATION

This application claims priority to India Provisional Pat. Application No. 202141039071, filed on Aug. 28, 2021, and entitled “LINKAGE DATA GENERATOR,” the entirety of which application is hereby incorporated by reference herein.

### TECHNICAL FIELD

The disclosed subject matter generally relates to data storage and retrieval, and more particularly to generating and classifying links between data.

### BACKGROUND

Organizations often possess thousands or even millions of data tables across many schemas, representing an immense volume of information. Such data tables are typically siloed within the teams that own such data tables. This results in low visibility of relationships between data tables, making it difficult to find related data across them. For various reasons, such as data disposal for regulatory compliance, data from a variety of databases (e.g., MySQL, Oracle, TeraData, or other suitable databases) and respective data tables often need to be discovered, checked, and cross-referenced to ensure compliance. Insight into relationships between data tables is often lost over time, and recreating such links can be a tedious and resource-intensive. Consequently, as organizations continue to amass more and more data, it is becoming increasingly difficult to trace user data across databases for the purpose of data discovery, redundancy reduction, and data privacy compliance, among other reasons. Existing linkage solutions use granular data to provide data-level connections (e.g., connecting values record by record) which can lead to low performance, low scalability, high costs, and various limitations.

### BRIEF DESCRIPTION OF DRAWINGS

FIG. 1 is a block diagram of an exemplary system in accordance with one or more embodiments described herein.

FIG. 2 is a block diagram of an exemplary system in accordance with one or more embodiments described herein.

FIG. 3 is a flowchart of an exemplary data linkage cycle in accordance with one or more embodiments described herein.

FIG. 4 is a flowchart of an example method for data linkage generation in accordance with one or more embodiments described herein.

FIG. 5 is a block flow diagram for a process for data linkage generation in accordance with one or more embodiments described herein.

FIG. 6 is an example, non-limiting computing environment in which one or more embodiments described herein can be implemented.

FIG. 7 is an example, non-limiting networking environment in which one or more embodiments described herein can be implemented.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

According to an embodiment, a system can comprise a processor and a non-transitory computer-readable medium having stored thereon computer-executable instructions that are executable by the system to cause the system to perform operations comprising determining a cluster of tables from a plurality of tables, determining, using a neural network, a link between a pair of columns from respective tables of the cluster of tables, wherein the pair of columns satisfy a relatedness criterion, and classifying, using the neural network, the link according to a link classification criterion, wherein the link satisfies the link classification criterion.

Such a system can be enabled to scan through data, data tables, and/or associated metadata of various databases to intelligently identify connections between various data tables using one or more of machine learning algorithms and/or neural networks to ensure high accuracy and efficiency. Such metadata can comprise, for instance, table name, data type, timestamps, column length, last access time and/or other suitable metadata. In one or more embodiments, the neural network can comprise a Siamese neural network. The system can thereby create a granular data model of all tables (e.g., in a particular schema or database) and store such information in a repository of linked data. By linking or joining various tables, data can be retrieved, or disposed of more quickly and accurately, while reducing resource costs. It is noted that, in some embodiments, the above operations can further comprise storing data represented in the pair of columns in a temporary data store.

In some embodiments, the above operations can further comprise verifying the classification of the link (e.g., using a sample join query), and in response to a determination that the link comprises a positive link, storing data represented in the pair of columns (e.g., in a final linkage inventory), or in response to a determination that the link comprises a false-positive link, generating feedback data associated with the false-positive link. In some embodiments, the operations can comprise removing the link between the pair of columns after generating the feedback data associated with the false-positive link.

In various embodiments, the above operations can further comprise adjusting the neural network based upon a result of verifying the classification of the link (e.g., using a sample join query). In some embodiments, augmented data can be introduced into the neural network, wherein the neural network is adjusted based on a result of classifying the augmented data. In an embodiment, the above-described neural network has been applied to past links between other pairs of columns other than the pair of columns.

In various embodiments, the above operations can further comprise purging the pair of columns from the plurality of tables. It is noted that the pair of columns can be purged in response to a determination that data represented in the pair of columns are subject to a data privacy requirement (e.g., according to the General Data Protection Regulation (GDPR)).

In another embodiment, a computer-implemented method comprises determining, by a computer system comprising a processor, a data subgroup comprising a subgroup of data tables of a group of data tables by filtering the group of data tables, determining, by the computer system and using machine learning, correlated data comprising a correlation between data from respective data tables of the subgroup of data tables, wherein the correlated data satisfy a cluster criterion, and classifying, by the computer system and using the machine learning, the correlated data according to a classification criterion, wherein the correlated data satisfy the classification criterion.

In various embodiments, the above method can further comprise generating, by the computer system, a graphical user interface representative of the correlated data. It is noted that the group of tables can be received via the graphical user interface.

In one or more embodiments, the correlated data comprise respective metadata associated with the group of data tables.

It is additionally noted that, in some embodiments, the classification criterion is based in part on a group of classification factors, and wherein the group of classification factors are weighted using machine learning according to respective relative importance. In this regard, the group of classification factors can comprise at least one of table name, column name, and data type. In other embodiments, the group of classification factors comprise metadata, which can comprise at least one of table name, data type, timestamps, column length, last access time and/or other suitable metadata, or some combination of the foregoing.

In yet another embodiment, a computer-program product for facilitating data linkage can comprise a computer-readable medium having program instructions embedded therewith, the program instructions executable by a computer system to cause the computer system to perform operations comprising determining a data cluster comprising a cluster of tables of a plurality of tables, determining, using a neural network, a link between a pair of columns from respective tables of the cluster of tables, wherein the pair of columns satisfy a relatedness criterion, and classifying, using the neural network, the link according to a link classification criterion, wherein the link satisfies the link classification criterion.

It is noted that the above operations can further comprise receiving a target for the link based upon a data privacy compliance requirement, and in response to the link being determined to satisfy the link classification criterion, purging data associated with the link from the plurality of tables.

In various embodiments, the above operations can further comprise, in response to the link being determined to satisfy the link classification criterion, adjusting the link classification criterion using a tuning model, wherein the tuning model has been generated using machine learning applied to past link classification information representative of past links of other pairs of columns in other tables other than the plurality of tables.

The foregoing can, for instance, enable account-level tracking of personal information across an organization which can be facilitated by establishing such links, which can be pivotal in ensuring, for instance, data privacy compliance, accurate and complete data disposal, and data subject request compliance.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings.

It should be appreciated that additional manifestations, configurations, implementations, protocols, etc. can be utilized in connection with the following components described herein or different/additional components as would be appreciated by one skilled in the art.

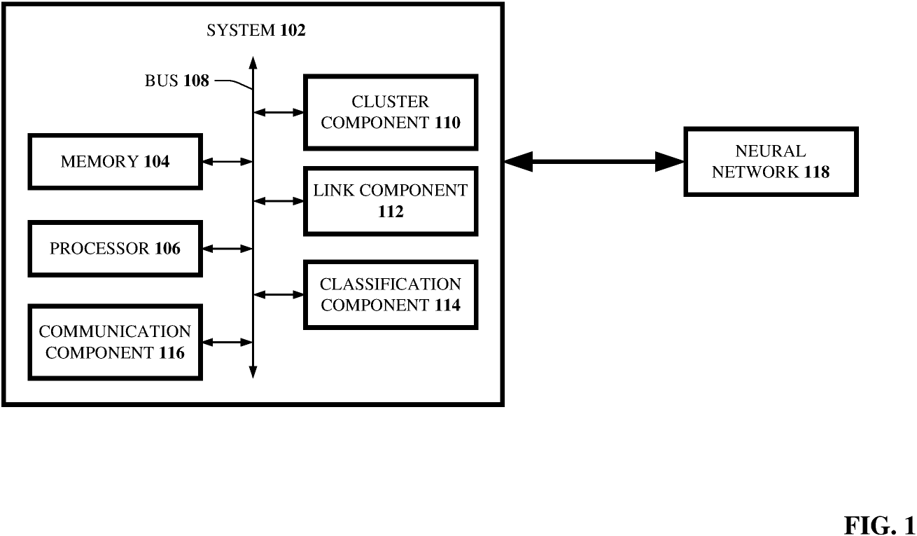

Turning now to FIG. 1, there is illustrated an example, non-limiting system 102 in accordance with one or more embodiments herein. System 102 can comprise a computerized tool (e.g., any suitable combination of computer-executable hardware and/or computer-executable software) which can be configured to perform various operations relating to data linkage generation. The system 102 can comprise one or more of a variety of components, such as memory 104, processor 106, bus 108, cluster component 110, link component 112, classification component 114, and/or communication component 116. It is noted that the system 102 can be communicatively coupled to a neural network 118. In other embodiments, the system 102 can comprise the neural network 118.

In various embodiments, one or more of the memory 104, processor 106, bus 108, cluster component 110, link component 112, classification component 114, communication component 116, and/or neural network 118 can be communicatively or operably coupled (e.g., over a bus or wireless network) to one another to perform one or more functions of the system 102.

According to an embodiment, the cluster component 110 can determine a cluster of tables (e.g., from a plurality of data tables in a database or schema). Determining the cluster of tables can be considered initial clustering, which can comprise filtering of the data in the data tables. Such filtering can comprise keyword searching, identifying specific times or ranges of time for data creation or modification, searching for threshold values, or other suitable methods for data filtering. Such filtering / initial clustering can reduce the initial tables into one or more clusters of tables. For instance, 60,000 data tables could be reduced to 60 clusters of tables that can each comprise 1,000 data tables. In this regard, the disclosed filtering can result in a plurality of clusters of tables. It is noted that such clustering can be performed, for instance, based on metadata of respective tables and/or on the data themselves (e.g., of columns of the respective data tables).

The link component 112 can utilize the neural network 118 in order to generate one or more links between a pair of columns from respective data tables of the cluster of data tables. In various embodiments, such links can comprise a correlation between respective tables and/or pairs of columns, which can be based on respective metadata associated with the group of data tables or on the data contained within columns of data tables. It is noted that pair(s) of columns can be determined (e.g., by the link component and/or neural network 118) to satisfy a relatedness criterion. Such a relatedness criterion can comprise, for instance, threshold overlap between columns of different data tables. In this regard, the relatedness criterion can comprise a percentage of overlap of data and/or metadata. In one or more embodiments, such a relatedness criterion can be generated, for instance, using machine learning applied to past relatedness information representative of past relationships between data, metadata, or data tables or columns.

In some embodiments, the communication component 116 can be utilized to communicate with the neural network 118. It is noted that the communication component 116 can possess the hardware required to implement a variety of communication protocols (e.g., infrared (“IR”), shortwave transmission, near-field communication (“NFC”), Bluetooth, Wi-Fi, long-term evolution (“LTE”), 3G, 4G, 5G, 6G, global system for mobile communications (“GSM”), code-division multiple access (“CDMA”), satellite, visual cues, radio waves, etc.)

According to an embodiment, the classification component 114 can utilize the neural network 118 in order to classify the previously generated links according to a link classification criterion. It is noted that that such a classification can be made by the link satisfying the link classification criterion. In this regard, the link classification criterion can comprise one or more of a category of data, type of data, or another criterion. For instance, data with known values can be utilized to predict (e.g., by the classification component 114) unknown values of other data. In various instances, link classifications herein can comprise any suitable label that indicates one or more classes to which the data candidate belongs.

In various aspects, the neural network 118 can exhibit any suitable deep learning architecture. For instance, in various cases, the neural network 118 can comprise any suitable number of layers. In various instances, the neural network 118 can comprise any suitable numbers of neurons in various layers (e.g., different layers can have the same and/or different numbers of neurons as each other). In various aspects, the neurons of the neural network 118 can comprise any suitable activation functions (e.g., different neurons can have the same and/or different activation functions as each other), such as sigmoid, Softmax, rectified linear unit, and/or hyperbolic tangent. In various cases, the neural network 118 can implement any suitable interneuron connectivity patterns (e.g., forward connections, skip connections, recurrent connections).

In various aspects, the neural network 118 can be configured to receive as input a cluster of tables and to produce as output one or more links between a pair of columns from respective tables of the cluster of tables. It is noted that in one or more embodiments, the neural network 118 can comprise a Siamese neural network, which can comprise a twin network which utilizes common weights while working in tandem on two different input vectors to compute comparable output vectors. In various instances, data tables or columns can comprise therein any suitable number of scalars, any suitable number of vectors, any suitable number of matrices, any suitable number of tensors, any suitable number of character strings, and/or any suitable combination thereof. For example, the data tables or columns can, in some cases, comprise one or more images or sound recordings. As yet another example, the data candidate can, in some cases, be timeseries data. In this regard, tables, clusters, or columns herein can comprise any other suitable type of data.

Although the herein disclosure discloses embodiments in which the neural network 118 is configured to classify inputted cluster of tables, this is a mere non-limiting example. In various aspects, the neural network 118 can be configured to produce any suitable type and/or format of output data. As another example, in some cases, the neural network 118 can be configured to produce as output one or more forecasted scalars, vectors, matrices, tensors, character strings, and/or any suitable combination thereof.

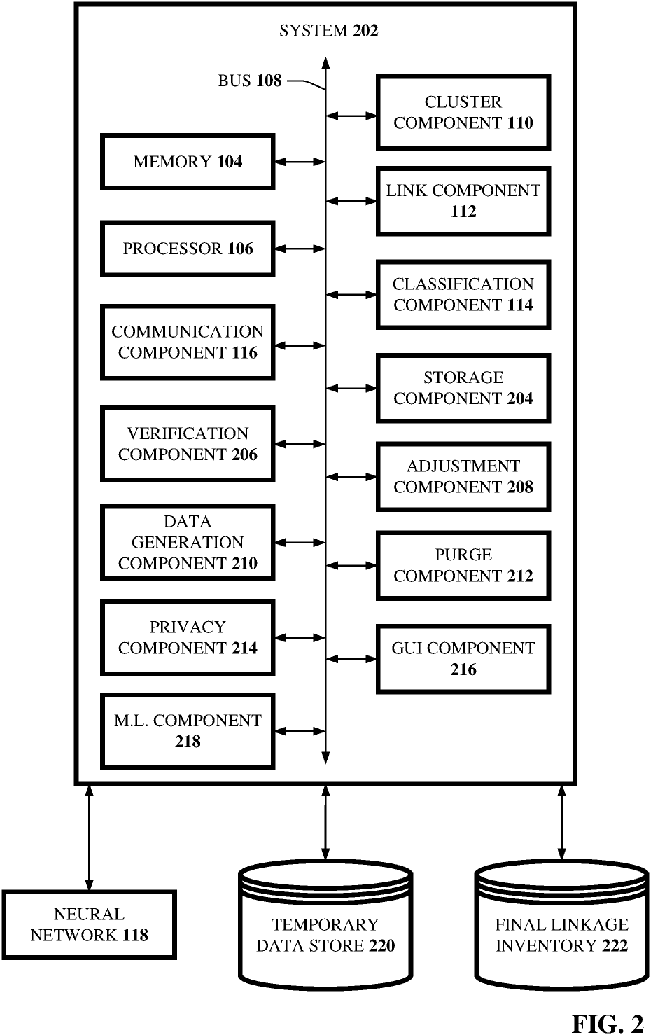

Turning now to FIG. 2, there is illustrated an example, non-limiting system 202 in accordance with one or more embodiments herein. System 202 can comprise a computerized tool (e.g., any suitable combination of computer-executable hardware and/or computer-executable software) which can be configured to perform various operations relating to data linkage generation. The system 202 can comprise one or more of a variety of components, such as memory 104, processor 106, bus 108, cluster component 110, link component 112, classification component 114, communication component 116, neural network 118, storage component 204, verification component 206, adjustment component 208, data generation component 210, purge component 212, privacy component 214, and/or graphical user interface (GUI) component 216. Repetitive description of like elements and/or processes employed in respective embodiments is omitted for sake of brevity. It is noted that the system 202 can be communicatively coupled to a temporary data store 220 and/or a final linkage inventory 222. In other embodiments, the system 102 can comprise the temporary data store 220 and/or final linkage inventory 222.

According to an embodiment, the storage component 204 can store data tables and/or data represented in pair(s) of columns in a temporary data store 220 or a final linkage inventory 222. According to an example, such data can remain in the temporary data store 220 until further processing of the data is performed or the respective data, data tables, columns, etc. are determined to be purged or moved into a final linkage inventory 222 (e.g., using the storage component 204).

The verification component 206 can verify a classification of a link (e.g., made by the classification component 114), for instance, using a sample join query. In this regard, columns of different respective tables can be combined (e.g., permanently or temporarily) based a common related column between the two or more data tables. Further in this regard, in response to a determination by the verification component 206 that the link represents a positive link, the verification component 206 can cause the storage component 204 to store data represented in a pair of columns into a final linkage inventory 222. Conversely, in response to a determination by the verification component 206 that the link represents a false-positive link, the verification component 206 can generate feedback data associated with the false-positive link (e.g., for neural network training). In other embodiments, the verification component 206 can cause the link component 112 to remove the link between the pair of columns and/or remove associated data or tables from the temporary data store 220 (e.g., using the storage component 204 and/or purge component 212) after generating such feedback data.

The adjustment component 208 can, according to an embodiment, adjust the neural network 118 based upon a result of verifying the classification of the link (e.g., by the verification component 206) using the sample join query. In some embodiments, augmented data can be introduced into the neural network 118 (e.g., for neural network training purposes). In this regard, the neural network 118 can be adjusted or tuned based upon a result of classifying (e.g., by the classification component 114) the augmented data. It is noted that such augmented data can comprise fuzzy data or fuzzy sets of data, which can be generated (e.g., by a data generation component 210) using random generation or generated according to a defined augmented data generation function. In other embodiments, the augmented data can comprise randomly modified historical data. It is further noted that various data patterns information can be utilized for neural network 118 and/or associated training or for improvement of a tuning model employed by the adjustment component 208. The foregoing can enable the neural network 118 and/or associated model to train with data and/or patterns not previously experienced by the neural network 118 or a model (e.g., a tuning model), which can improve neural network predictions.

According to an embodiment, in response to the link being determined to satisfy the link classification criterion (e.g., by the classification component 114), the adjustment component 208 adjusting the link classification criterion using a tuning model, which can be generated using machine learning (e.g., using the M.L. component 218) applied to past link classification information representative of past links of other pairs of columns in other data tables other than the plurality of tables.

In an embodiment, the purge component 212 can purge a pair of columns from a plurality of data tables. The purge component 212 can perform the foregoing, for instance, in response to receiving (e.g., via the communication component 116) a command or a signal representative of an instruction to purge said pair of columns or different column(s). It is noted that the pair of columns can be purged by the purge component 212 in response to receiving an instruction from the privacy component 214. In this regard, the privacy component 214 can determine that data represented in the pair of columns are subject to a data privacy requirement (e.g., GDPR). The privacy component 214 can make such a determination according to a defined privacy criterion associated with such a data privacy requirement. In one or more embodiments, such a privacy criterion can be generated, for instance, using machine learning applied to past privacy information associated with various data, metadata, or data tables or columns.

In an embodiment, the GUI component 216 can generate a GUI in/on one or more mediums. For instance, the GUI component 216 can generate a GUI in/on the system 202 or a device or medium communicatively coupled to the system 202 (e.g., on a mobile device, computer, website, etc.) Such a GUI component 216 can facilitate generation of a display of system performance, enable commands to be received by the system 202, display information representative of related or correlated data, or other suitable information.

According to an embodiment, a group of data tables can be received via the GUI component 216. It is noted that a target for a link based upon a data privacy compliance requirement can be received (e.g., via the GUI component 216 or the communication component 116). In response to the link being determined to satisfy a link classification criterion (e.g., by the classification component 114), the purge component 212 can purge data associated with the link from the plurality of tables (e.g., from the temporary data store 220, final linkage inventory 222, or another communicatively coupled data store, database, or schema).

It is noted that classification criteria herein can be based, at least in part, on a group of classification factors (e.g., metadata parameters). It is additionally noted that a group of classification factors (e.g., metadata parameters such as table name, data type, timestamps, etc.) can be weighted using machine learning (e.g., using the machine learning (ML) component 218) according to respective relative importance, and said weights can be provided to the neural network 118. In other embodiments, said weights can be modified in response to receiving a weight adjustment signal or command (e.g., via the communication component 116). In various embodiments, the group of classification factors can comprise one or more of a combination of table name, column name, data type, column length, last access time, timestamp, or other suitable classification factors. It is noted that classification can be based on data table metadata, data table column content, or other suitable information. In an embodiment, certain classification factors (e.g., table name, column name, and length of column, data type) can be weighted more heavily than other classification factors (e.g., timestamp or last access time).

Various embodiments herein can employ artificial-intelligence or machine learning systems and techniques to facilitate learning user behavior, context-based scenarios, preferences, etc. in order to facilitate taking automated action with high degrees of confidence. Utility-based analysis can be utilized to factor benefit of taking an action against cost of taking an incorrect action. Probabilistic or statistical-based analyses can be employed in connection with the foregoing and/or the following.

It is noted that systems and/or associated controllers, servers, or ML components (e.g., ML component 218) herein can comprise artificial intelligence component(s) which can employ an artificial intelligence (AI) model and/or ML or an ML model that can learn to perform the above or below described functions (e.g., via training using historical training data and/or feedback data).

In some embodiments, ML component 218 can comprise an AI and/or ML model that can be trained (e.g., via supervised and/or unsupervised techniques) to perform the above or below-described functions using historical training data comprising various context conditions that correspond to various management operations. In this example, such an AI and/or ML model can further learn (e.g., via supervised and/or unsupervised techniques) to perform the above or below-described functions using training data comprising feedback data, where such feedback data can be collected and/or stored (e.g., in memory) by an ML component 218. In this example, such feedback data can comprise the various instructions described above/below that can be input, for instance, to a system herein, over time in response to observed/stored context-based information.

AI/ML components herein can initiate an operation(s) associated with a based on a defined level of confidence determined using information (e.g., feedback data). For example, based on learning to perform such functions described above using feedback data, performance information, and/or past performance information herein, an ML component 218 herein can initiate an operation associated with data linkage generation. In another example, based on learning to perform such functions described above using feedback data, performance information, and/or past performance information herein, an ML component 218 herein can initiate an operation associated with updating a model (e.g., a linkage model or tuning model).

In an embodiment, the ML component 218 can perform a utility-based analysis that factors cost of initiating the above-described operations versus benefit. In this embodiment, an artificial intelligence component can use one or more additional context conditions to determine appropriate data linkage or to determine an update for a linkage model.

To facilitate the above-described functions, an ML component herein can perform classifications, correlations, inferences, and/or expressions associated with principles of artificial intelligence. For instance, an ML component 218 can employ an automatic classification system and/or an automatic classification. In one example, the ML component 218 can employ a probabilistic and/or statistical-based analysis (e.g., factoring into the analysis utilities and costs) to learn and/or generate inferences. The ML component 218 can employ any suitable machine-learning based techniques, statistical-based techniques and/or probabilistic-based techniques. For example, the ML component 218 can employ expert systems, fuzzy logic, support vector machines (SVMs), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or the like. In another example, the ML component 218 can perform a set of machine-learning computations. For instance, the ML component 218 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations.

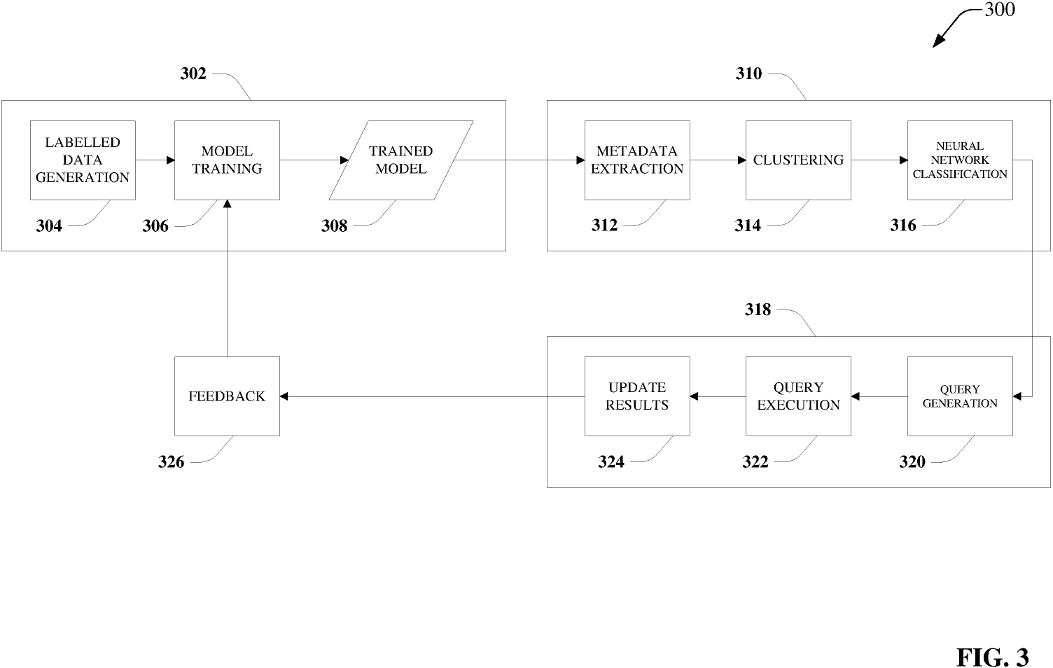

Turning now to FIG. 3, there is illustrated a flow chart of a process 300 for data linkage generation and model generation/tuning in accordance with one or more embodiments herein. At 302, model (e.g., data link model, tuning model, and/or neural network) training can occur (e.g., using the adjustment component 208 and verification component 206). At 304, a system (e.g., system 102 or 202) can generate labelled data. In other embodiments, labelled data can be received by the system (e.g., for model training or initialization purposes). Such labelled data can be located in prefixes, suffixes, metadata, and/or columns of data tables, and can be associated with ID names, datatypes, timestamps, or other suitable identifiers by which similarities can be evaluated. In an embodiment, machine learning can be utilized in order to generate and/or train said model at 306, resulting in a trained model at 308. At 310, prediction (e.g., by the system 102 or 202) can occur. At 312, metadata can be extracted from production tables or other suitable data tables (e.g., using the cluster component 110). At 314, clustering (e.g., filtering) can be performed (e.g., using the cluster component 110). In this regard, tables can be reduced to clusters of tables. Next, said clusters can be input into a neural network (e.g., neural network 118) in order to predict whether columns or other aspects of data tables should be linked. In other embodiments, such links can be generated (e.g., using the link component 112). It is noted that the neural network 118 can be trained to predict whether columns of different data tables are related (e.g., based on comparison of the content of respective columns). In this regard, the neural network 118 can learn to predict whether columns of different data tables are related. At 318, verification can occur, for instance, by employing a sample join query (e.g., using the verification component 206). At 320, a system herein can generate a query for link verification. At 322, said query (e.g., a sample join query) can be executed and verified (e.g., using the verification component 206). In this regard, data from two linked columns can be sampled and checked for similarity (e.g., using the verification component 206). If said sampling yields a defined threshold level of data overlap between the columns, then the link can be verified as a proper link (e.g., by the verification component 206). Alternatively, if said sampling does not yield a threshold level of data overlap between the columns, the link can be discarded (e.g., by the verification component 206 and purge component 212). At 326, feedback can be generated (e.g., using the verification component 206) for use in training of the neural network 118 (e.g., with the adjustment component 208). In this regard, results from the verification steps can be utilized to improve the model (e.g., a tuning model) at 306.

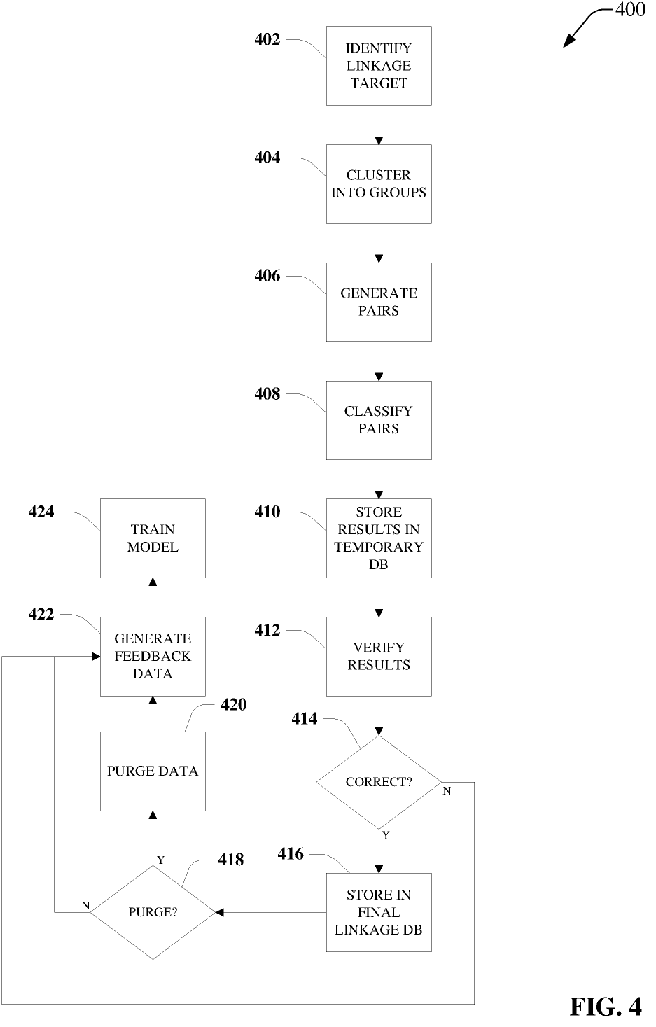

With reference to FIG. 4, there is illustrated a flow chart of a process 400 for data linkage generation and model generation/tuning in accordance with one or more embodiments herein. At 402, linkage target(s) can be identified or received (e.g., by a system 102 or system 202). In this regard, a particular database or schema can be identified (e.g., using the cluster component 110). In other embodiments, the communication component 116 can receive or access information representative of linkage target(s).

At 404, target tables can be clustered into groups (e.g., clusters using a cluster component 110). For example, a cluster of tables can be filtered based on data in the data tables of the cluster of data tables. In this regard, keyword searching can be performed, specific times or ranges of time for data creation and/or modification can be determined, threshold values can be searched for, or other suitable data filtering procedures can be employed.

At 406, pairs (e.g., links) between columns can be generated (e.g., for each cluster using a link component 112). In one or more embodiments, a neural network 118 can be leveraged in order to determine columns that satisfy a relatedness criterion. In other embodiments, the link component 112 can determine columns that satisfy the relatedness criterion. In various embodiments, a relatedness criterion can comprise a percentage overlap of data and/or associated metadata. In this regard, such data or metadata (e.g., pairs of data and/or metadata) can be determined to satisfy the relatedness criterion.

At 408, said pairs can be classified (e.g., by the classification component 114 and/or by employing a neural network 118 such as a Siamese network). In this regard, a link classification criterion can be generated (e.g., by a neural network 118) in order to classify new links (e.g., that satisfy a link classification criterion). In other embodiments, the link classification criterion can be received or accessed (e.g., via the communication component 116). At 410, results of the linking and classification can be stored in a temporary database (e.g., temporary data store 220 using a storage component 204).

At 412, classification results can be verified by running a sample join query using one or more column pairs (e.g., using a verification component 206). In this regard, columns of different respective tables can be combined (e.g., permanently or temporarily) based a common related column between the two or more data tables. At 414, if the classification results are verified as correct, the process can proceed to 416. At 416, the data, associated links, and classification can be stored in a final linkage database (e.g., final linkage inventory 222) (e.g., using the storage component 204). If at 414, the verification fails, the process can proceed to 422. At 418, if the verified data is to be purged (e.g., subject to a data privacy removal request via the privacy component 214), the data can be purged (e.g., deleted) at 420 (e.g., using the purge component 212). In one or more embodiments, the communication component 116 can receive or access information regarding whether to purge the data. In other embodiments, such a request can be received via the GUI component 206. If the verified data is not to be purged at 418, the process can proceed to 422.

At 422, feedback data (e.g., associated with the verification at 412) can be generated (e.g., using the verification component 206), which can be utilized in order to train the neural network and/or associated model at 424 (e.g., using the adjustment component 208). In other embodiments, feedback data can be received (e.g., via the communication component 116 and/or GUI component 216).

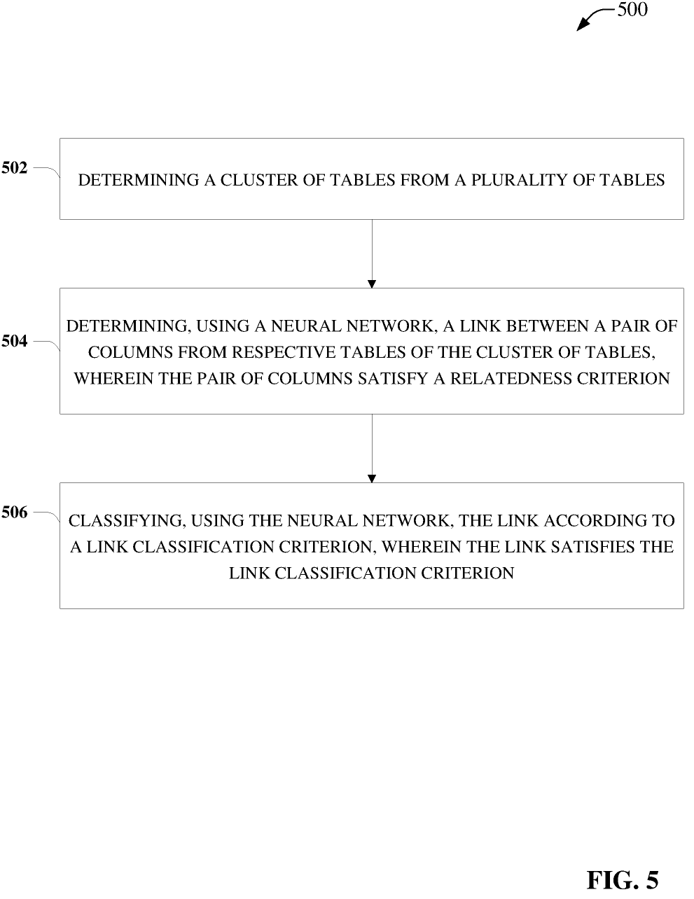

FIG. 5 illustrates a block flow diagram for a process 500 for data linkage generation in accordance with one or more embodiments described herein. At 502, the process 500 can comprise determining a cluster of tables from a plurality of tables (e.g., using a cluster component 110). In this regard, initial clustering can be performed at 502. For instance, keyword searching, identifying specific times or ranges of time for data creation or modification, searching for threshold values, or other suitable methods for data filtering can be performed which can reduce initial data tables into one or more clusters of data tables. In this regard, a cluster of data tables can be generated. In various embodiments clustering at 502 can be performed based on metadata of respective tables or on data of columns of data tables herein.

At 504, the process 500 can comprise determining, using a neural network (e.g., using neural network 118 by a link component 112), a link between a pair of columns from respective tables of the cluster of tables, wherein the pair of columns satisfy a relatedness criterion. In an embodiment, the relatedness criterion can comprise threshold overlap between columns of different data tables. In this regard, the relatedness criterion can comprise a percentage of overlap of data and/or metadata. In one or more embodiments, such a relatedness criterion can be generated, for instance, using machine learning (e.g., using the ML component 218) applied to past relatedness information representative of past relationships between data, metadata, or data tables or columns.

At 506, the process 500 can comprise classifying (by the classification component 114), using the neural network (e.g., neural network 118), the link according to a link classification criterion, wherein the link satisfies the link classification criterion. In this regard, according to an embodiment, such a link classification criterion herein can comprise one or more of a category of data, type of data, or other suitable criterion. According to an example, data with known values can be utilized, for instance, to predict (e.g., by the classification component 114) unknown values of other data, other than the data of the instant columns and/or tables. In various embodiments, link classifications herein can comprise any suitable label that satisfies the link classification criterion and that indicates one or more classes to which the data candidate represents.

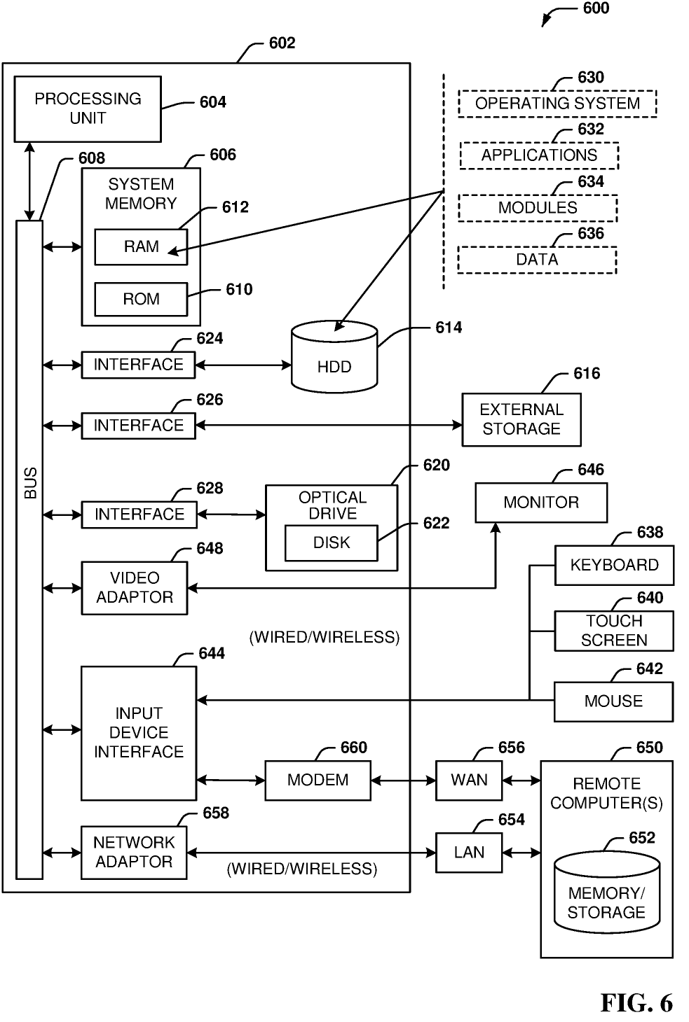

In order to provide additional context for various embodiments described herein, FIG. 6 and the following discussion are intended to provide a brief, general description of a suitable computing environment 600 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 6, the example environment 600 for implementing various embodiments of the aspects described herein includes a computer 602, the computer 602 including a processing unit 604, a system memory 606 and a system bus 608. The system bus 608 couples system components including, but not limited to, the system memory 606 to the processing unit 604. The processing unit 604 can be any of various commercially available processors. Dual microprocessors and other multi-processor architectures can also be employed as the processing unit 604.

The system bus 608 can be any of several types of bus structure that can further interconnect to a memory bus (with or without a memory controller), a peripheral bus, and a local bus using any of a variety of commercially available bus architectures. The system memory 606 includes ROM 610 and RAM 612. A basic input/output system (BIOS) can be stored in a non-volatile memory such as ROM, erasable programmable read only memory (EPROM), EEPROM, which BIOS contains the basic routines that help to transfer information between elements within the computer 602, such as during startup. The RAM 612 can also include a high-speed RAM such as static RAM for caching data.

The computer 602 further includes an internal hard disk drive (HDD) 614 (e.g., EIDE, SATA), one or more external storage devices 616 (e.g., a magnetic floppy disk drive (FDD) 616, a memory stick or flash drive reader, a memory card reader, etc.) and an optical disk drive 620 (e.g., which can read or write from a CD-ROM disc, a DVD, a BD, etc.). While the internal HDD 614 is illustrated as located within the computer 602, the internal HDD 614 can also be configured for external use in a suitable chassis (not shown). Additionally, while not shown in environment 600, a solid-state drive (SSD) could be used in addition to, or in place of, an HDD 614. The HDD 614, external storage device(s) 616 and optical disk drive 620 can be connected to the system bus 608 by an HDD interface 624, an external storage interface 626 and an optical drive interface 628, respectively. The interface 624 for external drive implementations can include at least one or both of Universal Serial Bus (USB) and Institute of Electrical and Electronics Engineers (IEEE) 1694 interface technologies. Other external drive connection technologies are within contemplation of the embodiments described herein.

The drives and their associated computer-readable storage media provide nonvolatile storage of data, data structures, computer-executable instructions, and so forth. For the computer 602, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 612, including an operating system 630, one or more application programs 632, other program modules 634 and program data 636. All or portions of the operating system, applications, modules, and/or data can also be cached in the RAM 612. The systems and methods described herein can be implemented utilizing various commercially available operating systems or combinations of operating systems.

Computer 602 can optionally comprise emulation technologies. For example, a hypervisor (not shown) or other intermediary can emulate a hardware environment for operating system 630, and the emulated hardware can optionally be different from the hardware illustrated in FIG. 6. In such an embodiment, operating system 630 can comprise one virtual machine (VM) of multiple VMs hosted at computer 602. Furthermore, operating system 630 can provide runtime environments, such as the Java runtime environment or the .NET framework, for applications 632. Runtime environments are consistent execution environments that allow applications 632 to run on any operating system that includes the runtime environment. Similarly, operating system 630 can support containers, and applications 632 can be in the form of containers, which are lightweight, standalone, executable packages of software that include, e.g., code, runtime, system tools, system libraries and settings for an application.

Further, computer 602 can be enable with a security module, such as a trusted processing module (TPM). For instance, with a TPM, boot components hash next in time boot components, and wait for a match of results to secured values, before loading a next boot component. This process can take place at any layer in the code execution stack of computer 602, e.g., applied at the application execution level or at the operating system (OS) kernel level, thereby enabling security at any level of code execution.

A user can enter commands and information into the computer 602 through one or more wired/wireless input devices, e.g., a keyboard 638, a touch screen 640, and a pointing device, such as a mouse 642. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 604 through an input device interface 644 that can be coupled to the system bus 608, but can be connected by other interfaces, such as a parallel port, an IEEE 1394 serial port, a game port, a USB port, an IR interface, a BLUETOOTH® interface, etc.

A monitor 646 or other type of display device can be also connected to the system bus 608 via an interface, such as a video adapter 648. In addition to the monitor 646, a computer typically includes other peripheral output devices (not shown), such as speakers, printers, etc.

The computer 602 can operate in a networked environment using logical connections via wired and/or wireless communications to one or more remote computers, such as a remote computer(s) 650. The remote computer(s) 650 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 652 is illustrated. The logical connections depicted include wired/wireless connectivity to a local area network (LAN) 654 and/or larger networks, e.g., a wide area network (WAN) 656. Such LAN and WAN networking environments are commonplace in offices and companies, and facilitate enterprise-wide computer networks, such as intranets, all of which can connect to a global communications network, e.g., the Internet.

When used in a LAN networking environment, the computer 602 can be connected to the local network 654 through a wired and/or wireless communication network interface or adapter 658. The adapter 658 can facilitate wired or wireless communication to the LAN 654, which can also include a wireless access point (AP) disposed thereon for communicating with the adapter 658 in a wireless mode.

When used in a WAN networking environment, the computer 602 can include a modem 660 or can be connected to a communications server on the WAN 656 via other means for establishing communications over the WAN 656, such as by way of the Internet. The modem 660, which can be internal or external and a wired or wireless device, can be connected to the system bus 608 via the input device interface 644. In a networked environment, program modules depicted relative to the computer 602 or portions thereof, can be stored in the remote memory/storage device 652. It will be appreciated that the network connections shown are example and other means of establishing a communications link between the computers can be used.

When used in either a LAN or WAN networking environment, the computer 602 can access cloud storage systems or other network-based storage systems in addition to, or in place of, external storage devices 616 as described above. Generally, a connection between the computer 602 and a cloud storage system can be established over a LAN 654 or WAN 656 e.g., by the adapter 658 or modem 660, respectively. Upon connecting the computer 602 to an associated cloud storage system, the external storage interface 626 can, with the aid of the adapter 658 and/or modem 660, manage storage provided by the cloud storage system as it would other types of external storage. For instance, the external storage interface 626 can be configured to provide access to cloud storage sources as if those sources were physically connected to the computer 602.

The computer 602 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

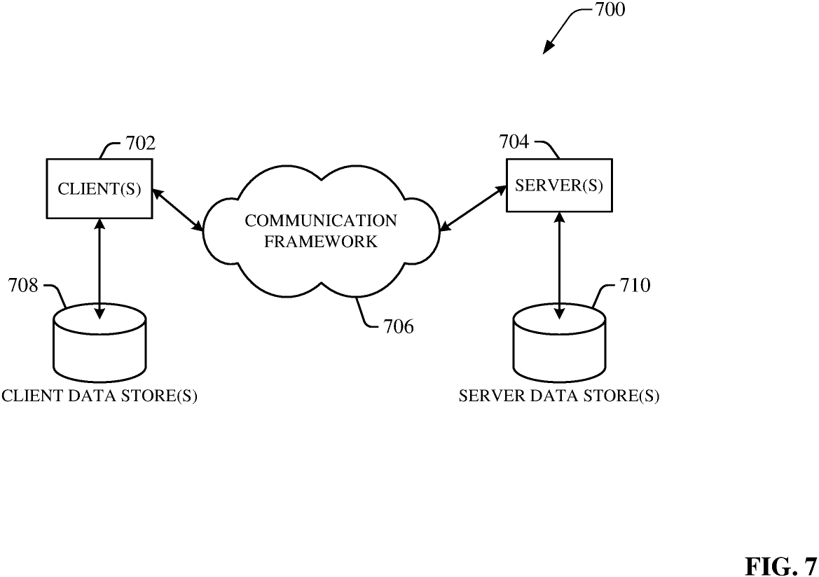

Referring now to FIG. 7, there is illustrated a schematic block diagram of a computing environment 700 in accordance with this specification. The system 700 includes one or more client(s) 702, (e.g., computers, smart phones, tablets, cameras, PDA’s). The client(s) 702 can be hardware and/or software (e.g., threads, processes, computing devices). The client(s) 702 can house cookie(s) and/or associated contextual information by employing the specification, for example.

The system 700 also includes one or more server(s) 704. The server(s) 704 can also be hardware or hardware in combination with software (e.g., threads, processes, computing devices). The servers 704 can house threads to perform transformations of media items by employing aspects of this disclosure, for example. One possible communication between a client 702 and a server 704 can be in the form of a data packet adapted to be transmitted between two or more computer processes wherein data packets may include coded analyzed headspaces and/or input. The data packet can include a cookie and/or associated contextual information, for example. The system 700 includes a communication framework 706 (e.g., a global communication network such as the Internet) that can be employed to facilitate communications between the client(s) 702 and the server(s) 704.

Communications can be facilitated via a wired (including optical fiber) and/or wireless technology. The client(s) 702 are operatively connected to one or more client data store(s) 708 that can be employed to store information local to the client(s) 702 (e.g., cookie(s) and/or associated contextual information). Similarly, the server(s) 704 are operatively connected to one or more server data store(s) 710 that can be employed to store information local to the servers 704.

In one exemplary implementation, a client 702 can transfer an encoded file, (e.g., encoded media item), to server 704. Server 704 can store the file, decode the file, or transmit the file to another client 702. It is noted that a client 702 can also transfer uncompressed file to a server 704 and server 704 can compress the file and/or transform the file in accordance with this disclosure. Likewise, server 704 can encode information and transmit the information via communication framework 706 to one or more clients 702.

The illustrated aspects of the disclosure may also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive - in a manner similar to the term “comprising” as an open transition word - without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a processor; and
a non-transitory computer-readable medium having stored thereon computer-executable instructions that are executable by the system to cause the system to perform operations comprising:
determining a cluster of tables from a plurality of tables;
determining, using a neural network, a link between a pair of columns from respective tables of the cluster of tables, wherein the pair of columns satisfy a relatedness criterion; and
classifying, using the neural network, the link according to a link classification criterion, wherein the link satisfies the link classification criterion.

2. The system of claim 1, wherein the operations further comprise:
storing data represented in the pair of columns in a temporary data store.

3. The system of claim 1, wherein the operations further comprise:
verifying the classification of the link using a sample join query; and
in response to a determination that the link comprises a positive link, storing data represented in the pair of columns in a final linkage inventory.

4. The system of claim 1, wherein the operations further comprise:
verifying the classification of the link using a sample join query; and
in response to a determination that the link comprises a false-positive link, generating feedback data associated with the false-positive link.

5. The system of claim 1, wherein the neural network comprises a Siamese neural network.

6. The system of claim 1, wherein the operations further comprise:
adjusting the neural network based upon a result of verifying the classification of the link using a sample join query.

7. The system of claim 6, wherein the operations further comprise:
introducing augmented data into the neural network, wherein the neural network is adjusted based on a result of classifying the augmented data.

8. The system of claim 1, wherein the neural network has been applied to past links between other pairs of columns other than the pair of columns.

9. The system of claim 1, wherein the operations further comprise:
purging the pair of columns from the plurality of tables.

10. The system of claim 9, wherein the pair of columns are purged in response to a determination that data represented in the pair of columns are subject to a data privacy requirement.

11. A computer-implemented method, comprising:
determining, by a computer system comprising a processor, a data subgroup comprising a subgroup of data tables of a group of data tables by filtering the group of data tables;
determining, by the computer system and using machine learning, correlated data comprising a correlation between data from respective data tables of the subgroup of data tables, wherein the correlated data satisfy a cluster criterion; and
classifying, by the computer system and using the machine learning, the correlated data according to a classification criterion, wherein the correlated data satisfy the classification criterion.

12. The computer-implemented method of claim 11, further comprising:
generating, by the computer system, a graphical user interface representative of the correlated data.

13. The computer-implemented method of claim 12, wherein the group of data tables are received via the graphical user interface.

14. The computer-implemented method of claim 11, wherein the correlated data comprise respective metadata associated with the group of data tables.

15. The computer-implemented method of claim 11, wherein the classification criterion is based in part on a group of classification factors, and wherein the group of classification factors are weighted using the machine learning according to respective relative importance.

16. The computer-implemented method of claim 15, wherein the group of classification factors comprise at least one of table name, column name, and data type.

17. The computer-implemented method of claim 15, wherein the group of classification factors comprise at least one of column length, last access time, and timestamp.

18. A computer-program product for facilitating data linkage, the computer-program product comprising a computer-readable medium having program instructions embedded therewith, the program instructions executable by a computer system to cause the computer system to perform operations comprising:
determining a data cluster comprising a cluster of tables of a plurality of tables;
determining, using a neural network, a link between a pair of columns from respective tables of the cluster of tables, wherein the pair of columns satisfy a relatedness criterion; and
classifying, using the neural network, the link according to a link classification criterion, wherein the link satisfies the link classification criterion.

19. The computer-program product of claim 18, wherein the operations further comprise:
receiving a target for the link based upon a data privacy compliance requirement; and
in response to the link being determined to satisfy the link classification criterion, purging data associated with the link from the plurality of tables.

20. The computer-program product of claim 18, wherein the operations further comprise:
in response to the link being determined to satisfy the link classification criterion, adjusting the link classification criterion using a tuning model, wherein the tuning model has been generated using machine learning applied to past link classification information representative of past links of other pairs of columns in other tables other than the plurality of tables.
